(19) United States
(12) Patent Application Publication
(10) Pub. No.: US 2020/0329383 A1
(43) Pub. Date: Oct. 15, 2020

(54) SOFTWARE DEFINED NETWORK OPTIMIZATION

(71) Applicant: British Telecommunications Public Limited Company, London (GB)

(72) Inventors: Andrew Starkey, London (GB); Carla Di Cairano-Gilfedder, London (GB); Anthony Conway, London (GB)

(21) Appl. No.: 16/808,915

(22) Filed: Mar. 4, 2020

(30) Foreign Application Priority Data
Mar. 4, 2019 (GB) 1902918.0

(51) Int. Cl. H04W 24/02; H04L 12/26; G06F 9/30; G06F 16/2458

(52) U.S. Cl. CPC H04W 24/02; H04L 43/08; H04W 72/00; G06F 16/2468; G06F 9/30007

(57) ABSTRACT

A computer implemented method of optimization of a software defined network (SDN) for a network application, the SDN including an SDN controller for configuring a plurality of network components to deliver a network service for the network application, each network component having a measurable metric for each of a plurality of characteristics of the component relating to a performance of the component, the method including accessing, for each network component, a measure for each of the metrics to classify the component for a characteristic corresponding to the metric according to a fuzzy logic classification scheme; defining a plurality of configurations of network components suitable for providing the network service; and selecting a configuration of the network components to provide the network application based on an optimization function optimizing the network components in terms of classifications of each network component.

### RELATED APPLICATION

The present application claims priority to GB Application No. 1902918.0 filed Mar. 4, 2019, which is hereby incorporated herein in its entirety by reference.

### TECHNICAL FIELD

The present disclosure relates to deployment of a software defined network. In particular it relates to optimization of network components involved in a software defined network.

### BACKGROUND

Software defined networks (SDNs) provide dynamic configuration of physical or virtualized network components such as switches and routers for the purpose of providing network services for network applications. Divided logically into a “data plane”, consisting of network components, and a “control plane”, consisting of logic for configuring and controlling the network components, a particular specification of an SDN configuration by an SDN controller seeks to provide network services in an efficient and reliable manner.

A specification of an SDN configuration by a controller to provide required network services can lead to service degradation or interruption as multiple network services are defined over time using the same network infrastructure including the network components. Thus, there is a challenge to provide for effective SDN configurations by SDN controllers that mitigate these problems.

### SUMMARY

According to a first aspect of the present disclosure, there is a provided a computer implemented method of optimization of a software defined network (SDN) for a network application, the SDN including an SDN controller for configuring a plurality of network components to deliver a network service for the network application, each network component having a measurable metric for each of a plurality of characteristics of the component relating to a performance of the component, the method comprising: accessing, for each network component, a measure for each of the metrics to classify the component for a characteristic corresponding to the metric according to a fuzzy logic classification scheme; defining a plurality of configurations of network components suitable for providing the network service; selecting a configuration of the network components to provide the network application based on an optimization function optimizing the network components in terms of classifications of each network component.

In some embodiments, the network component is a forwarding device such as a switch or router.

In some embodiments, the performance of a network component includes a degree of contention for the component.

In some embodiments, the method further comprises generating an aggregate classification for each network component based on the classifications of the network component such that the optimization function is operable on the basis of the aggregate classification.

In some embodiments, the method further comprises deploying the selected configuration via the SDN controller.

In some embodiments, the accessing, defining and selecting are performed repeatedly at one or more predetermined time intervals.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE FIGURES

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement for defining a configuration for a network service in a software defined network according to embodiments of the present disclosure.

FIG. 3 is a flowchart of a method of optimizing a software defined network for a network application according to embodiments of the present disclosure.

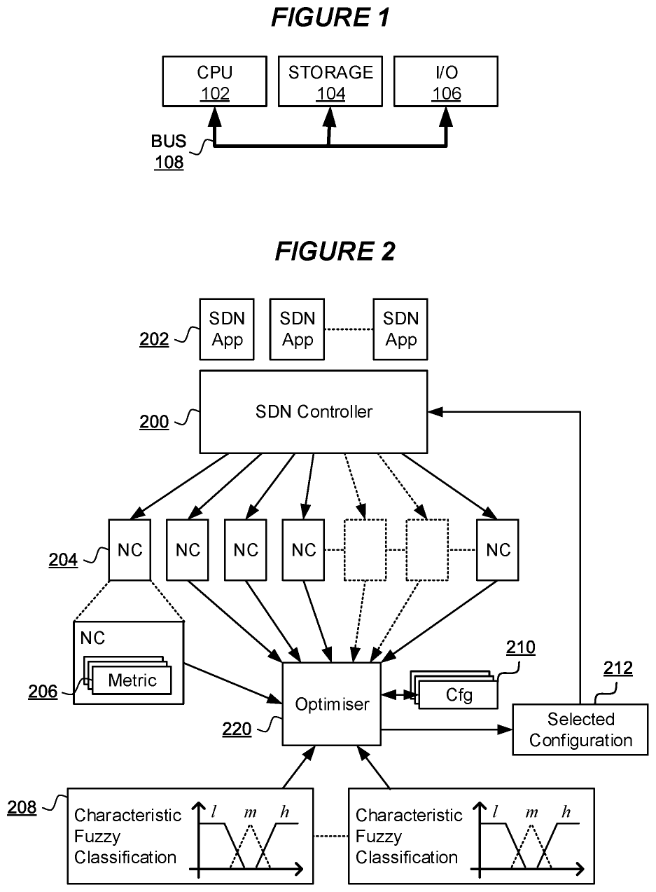

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection. FIG. 2 is a component diagram of an arrangement for defining a configuration for a network service in a software defined network (SDN) according to embodiments of the present disclosure. An SDN controller 200 is provided as a hardware, software, firmware or combination component or set of components for providing control functionality for a set of network components 204 providing, for example, data forwarding, switching and routing facilities. Thus, the SDN controller 200 implements a particular control configuration defining rules according to which the configuration of each of at least a subset of the network components 204 are configured. Such rules can include, for example, a routine, forwarding, data flow or switching rule for a network component 204.

The SDN controller 200 further provides interfaces, services and/or facilities for network applications 202 seeking to communicate via one or more networks. For example, the SDN controller 200 can provide flow control for one or more network components 204 using an SDN controller protocol such as OpenFlow. Examples of SDN controller 200 include: Beacon, a Java-based OpenFlow SDN controller that supports both event-based and threaded operation (see “The Beacon OpenFlow Controller” (David Erickson, Stanford University) available at http://yuba.stanford.edu/˜derickso/docs/hotsdn15-erickson.pdf; and OpenDaylight from the Linux Foundation (see “Open Daylight as a Controller for Software Defined Networking”), Badotra and Singh, 2015, IJARCS available from https://www.researchgate.net/publication/319547264_Open_Daylight_as_a_Controller_for_Software_Defined_Networking).

Network applications are provided as SDN applications 202 requiring communications services as network services provided by the SDN controller 200 using the network components 204. Each of the network components 204 is a physical or virtualized networking component such as a network switch, router or the like and is configurable by the SDN controller 200, such as by way of flow control, routing control, switching control and the like. Network components 204 include a plurality of measurable metrics 206, each metric 206 corresponding to a characteristic of the component relating to a performance of the component. For example, characteristics can include some or all of, inter alia: historical bandwidth availability; current bandwidth availability; historical data throughput; current data throughput; a degree of contention; a processor performance; a memory consumption; a memory availability; a measure of temperature; a degree of variability of a performance; a reliability measure; an uptime measure; a downtime measure; and other characteristics as will be apparent to those skilled in the art.

Embodiments of the present disclosure are operable to define a configuration for the SDN controller 200 as a set of one or more control rules to provide a network service required by an SDN application 202. In particular, the configuration is selected on the basis of metrics for each of the plurality of characteristics for each network component 204 so as to classify each component 204. Subsequently, a set of candidate controller configurations 210 are generated for selection therebetween to identify a selected controller configuration 212 for implementation by the SDN controller 200.

Thus, embodiments of the present disclosure provide an optimizer component 220 as a hardware, software, firmware or combination component for determining the selected configuration 212 for implementation by the SDN controller 200. The optimizer 220 accesses or receives, for each network component, a measure for each of the metrics 206 to classify the component according to a fuzzy classification scheme 208.

A fuzzy classification scheme 208 is provided for each of the characteristics for which metric measures are used by the optimizer 220. Fuzzy classification schemes are well known in the art and serve to classify quantitative information, such as a metric measure, into one of a plurality of classifications based on a degree of membership of the information with each of the classes. The classifications are defined across a range of memberships such that, for a particular quantitative measure, a prevailing classification can be determined for the measure. For example, three classes are depicted in the characteristic fuzzy classification 208 of FIG. 2 as “l”, “m” and “h” (e.g. low, medium and high). By way of example, for a characteristic corresponding to a degree of contention for a network component 204, measures of contention received as metrics 206 from network components 204 can be classified as “low contention”, “medium contention” or “high contention” based on the characteristic fuzzy classification 208.

Thus, in use, the optimizer 220 classifies each metric 206 for each network component 204 using characteristic fuzzy classifications 208. In consequence, all network components 204 will be classified across all measured characteristics. Subsequently, the optimizer 220 defines a set of candidate SDN configurations 210 as configurations suitable for providing a network service required by an SDN application 202. Each configuration 210 is a configuration of network components suitable for providing the network service for the application 202. The SDN configurations 210 in the candidate set can be determined by, for example: an exhaustive analysis of the network components 204 to determine all possible configurations; by a selective search of network components 204 based on search criteria to identify promising SDN configurations satisfying criteria such as performance and/or availability criteria; or other configuration definition strategies as will be apparent to those skilled in the art.

Embodiments of the present disclosure are operable to perform a selection from the set of candidate SDN configurations 210 based on an optimization function. For each candidate SDN configuration 210 the characteristic classifications obtained based on the fuzzy classification schemes 208 provide a parameter space suitable for an optimization algorithm such as a simulated annealing algorithm. The optimization can be objectified in dependence on requirements of the SDN application 202 such as, for example, low contention, high availability, high throughput, low downtime or a combination of multiple objectives. On the basis of such optimization function the optimizer 220 selects a candidate configuration 210 as the selected configuration 212 for implementation by the SDN controller 200.

In some embodiments, each of the network components 204 is further classified based on an aggregate classification of the individual characteristic classifications such that the optimizer 220 selects from the candidate configurations 210 on the basis of the aggregate classifications.

In some embodiments the process of the optimizer is repeated iteratively at predetermined intervals so as to provide a new SDN configuration accounting for a current, changed or updated state of the network components on a regular basis.

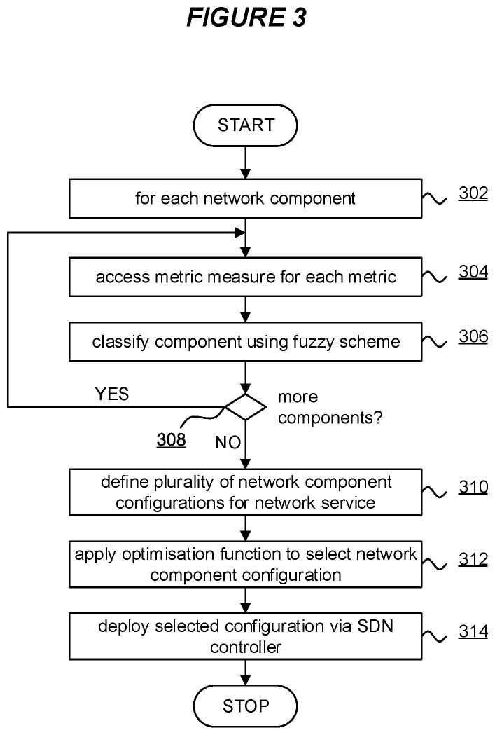

FIG. 3 is a flowchart of a method of optimizing an SDN for a network application 202 according to embodiments of the present disclosure. Initially, at 302, a loop is initiated through each of the set of network components 204. For each network component 202 a metric measure is accessed for each characteristic metric at 304 and the metrics are used to classify the component for each characteristic based on a fuzzy classification scheme at 306. The method loops for all network components at step 308 following which a set of candidate network component configurations 210 is defined at 310. At 312 an optimization function is applied to the set of candidate configurations 210 based on the fuzzy classifications of configurations 210 to select a configuration 212. The selected configuration is deployed at 314 by applying the selected configuration by the SDN controller 200.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure. It will be understood by those skilled in the art that, although the present disclosure has been described in relation to the above described example embodiments, the invention is not limited thereto and that there are many possible variations and modifications which fall within the scope of the invention.

The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of optimization of a software defined network (SDN) for a network application, the SDN including an SDN controller for configuring a plurality of network components to deliver a network service for the network application, each of the plurality of network components having a measurable metric for each of a plurality of characteristics of the network component relating to a performance of the network component, the method comprising:
accessing, for each of the plurality of network components, a measure for each of the measurable metrics to classify the network component for a characteristic corresponding to the measurable metric according to a fuzzy logic classification scheme;
defining a plurality of configurations of the network components suitable for providing the network service; and
selecting a configuration of the network components to provide the network application based on an optimization function optimizing the network components in terms of classifications of each network component.

2. The method of claim 1, wherein at least one of the plurality of network components is a forwarding device.

3. The method of claim 1, wherein the performance of at least one of the plurality of network components includes a degree of contention for the network component.

4. The method of claim 1, further comprising generating an aggregate classification for each of the plurality of network components based on the classifications of the network component such that the optimization function is operable based on the aggregate classification.

5. The method of claim 1, further comprising deploying the selected configuration via the SDN controller.

6. The method of claim 1, wherein the accessing, the defining and the selecting are performed repeatedly at one or more predetermined time intervals.

7. A computer system comprising:
a processor and memory storing computer program code for optimizing a software defined network (SDN) for a network application, the SDN including an SDN controller for configuring a plurality of network components to deliver a network service for the network application, each of the plurality of network components having a measurable metric for each of a plurality of characteristics of the network component relating to a performance of the network component, by:
accessing, for each of the plurality of network components, a measure for each of the measurable metrics to classify the network component for a characteristic corresponding to the measurable metric according to a fuzzy logic classification scheme;
defining a plurality of configurations of the network components suitable for providing the network service; and
selecting a configuration of the network components to provide the network application based on an optimization function optimizing the network components in terms of classifications of each network component.

8. A non-transitory computer-readable storage element storing computer program code to, when loaded into a computer system and executed thereon, cause the computer system to perform the method of claim 1.
